(19) United States
(12) Patent Application Publication
(10) Pub. No.: US 2022/0207513 A1
(43) Pub. Date: Jun. 30, 2022

(54) METHOD AND SYSTEM FOR INTEGRATED PAYMENT

(71) Applicant: CHINA UNIONPAY CO., LTD., Shanghai (CN)

(72) Inventors: Zhijun LU, Shanghai (CN); Haijian JIANG, Shanghai (CN); Lilin WANG, Shanghai (CN); Hua CAI, Shanghai (CN); Qing MIN, Shanghai (CN); Zheng ZHANG, Shanghai (CN)

(73) Assignee: CHINA UNIONPAY CO., LTD., Shanghai (CN)

(21) Appl. No.: 17/607,583

(22) PCT Filed: Mar. 25, 2020
(86) PCT No.: PCT/CN2020/081123

§ 371 Date: Oct. 29, 2021

(30) Foreign Application Priority Data
Apr. 30, 2019 (CN) 201910362767.1

(51) Int. Cl. G06Q 20/32; G06Q 20/38; H04L 67/563

(52) U.S. Cl. CPC G06Q 20/3276; H04L 67/2814; G06Q 20/382

(57) ABSTRACT

The present invention relates to a method and a system for integrated payment. The method for integrated payment includes: receiving, from a user terminal, a first access request corresponding to payment information; generating redirection address information on the basis of the first access request; and transmitting the redirection address information to the user terminal; wherein the redirection address information comprises jump target information and order information corresponding to a transaction order to be paid. The system for integrated payment includes: a receiving unit configured to receive a first access request from a user terminal; a redirection address information generating unit configured to generate redirection address information on the basis of the first access request; and a transmitting unit configured to transmit the redirection address information to the user terminal; where the redirection address information generating unit is further configured to encapsulate order information and transaction amount information corresponding to a transaction order to be paid into the redirection address information.

### CROSS-REFERENCE TO RELATED APPLICATIONS

This application is a National Stage of International Application No. PCT/CN2020/081123, filed on Mar. 25, 2020, which claims priority to Chinese Patent Application No. 201910362767.1, filed on Apr. 30, 2019, both of which are hereby incorporated by reference in their entireties for all purposes.

### TECHNICAL FIELD

The present application relates to the field of mobile payment. In particular, the present application relates to a method and a system for integrated payment at a user terminal and a system terminal.

### BACKGROUND

Change giving is necessary in traditional cash payment, which not only affects the transaction speed, but also worsens the user's consumer payment experience. At present, mobile payment through the user's device in daily transactions has been accepted by more and more consumers and become more and more popular. There are many ways of mobile payment for transactions, the most common of which is the payment performed by scanning a two-dimensional code (code scanning payment).

However, in the process of code scanning payment, the certain situations often occur, in which users scan two-dimensional codes through different third-party applications on their devices, so that a merchant is required to show the two-dimensional codes corresponding to the third-party applications used by the users; a payee needs to access the corresponding accounts to confirm whether the payment is successful; and in particular, when the merchant provides a specific type of two-dimensional code, a user has to use a third-party application interfacing with the provider of the two-dimensional code for scanning the code, resulting in poor user experience, and payment failure may be led to.

Moreover, in the completion of the payment, the system needs to frequently acquire order information associated with the transaction order from the merchant terminal, resulting in a significant signaling overhead between the merchant terminal, the user terminal, the system, and the acquirer.

### SUMMARY

Accordingly, there is a need for a method and a system for integrated payment that can support multiple third party applications to scan a two-dimensional code for payment. With the method and the system for integrated payment, when a merchant terminal presents a certain two-dimensional code, a user can be allowed to freely choose a third-party application which he often uses to perform two-dimensional code payment (the third-party application may not interface with the provider of the two-dimensional code), so that the user's good customer payment experience is effectively ensured. At the same time, key transaction information is specifically configured, so that the signaling overhead in the transaction process is saved.

For one or more of the above purposes, the present application provides the following technical solutions.

According to a first aspect of the present application, a method for integrated payment, including is provided, where the method includes: receiving, from a user terminal, a first access request corresponding to payment information; generating redirection address information on the basis of the first access request; and transmitting the redirection address information to the user terminal; where the redirection address information includes jump target information and order information corresponding to a transaction order to be paid.

According to a second aspect of the present application, a method for integrated payment is provided, where the method includes: acquiring, from a merchant terminal, payment information of an order; generating a first access request on the basis of the payment information; receiving redirection address information generated on the basis of the first access request; generating a second access request on the basis of the redirection address information; receiving a payment request based on the second access request; and making payment on the basis of the payment request; where the redirection address information includes jump target information and order information corresponding to a transaction order to be paid.

According to a third aspect of the present application, a system for integrated payment is provided, where the method includes: a receiving unit configured to receive a first access request from a user terminal; a redirection address information generating unit configured to generate redirection address information on the basis of the first access request; and a transmitting unit configured to transmit the redirection address information to the user terminal; where the redirection address information generating unit is further configured to encapsulate jump target information and order information corresponding to a transaction order to be paid into the redirection address information.

### BRIEF DESCRIPTION OF THE DRAWINGS

The foregoing and/or other aspects and advantages of the present application will be apparent and more readily appreciated from the following description of the aspects, taken in conjunction with the drawings. The same or similar elements in the drawings are represented by the same reference numerals. In the drawings:

FIG. 1 is a schematic flowchart of a method for integrated payment performed at a user terminal according to an embodiment of the present application;

FIG. 2 is a schematic diagram illustrating steps of generating redirection address information by a proxy service according to an embodiment of the present application;

FIG. 3 is a schematic flowchart of a method for integrated payment performed at a system terminal according to an embodiment of the present application;

FIG. 4 is a schematic flowchart of the steps of generating redirection address information of FIG. 3 according to an embodiment of the application;

FIG. 5 is a schematic diagram illustrating various contact relationships between a system terminal, a merchant terminal, a third party, and an acquirer according to an embodiment of the present application;

FIG. 6 is an overall timing diagram of a method for integrated payment according to an embodiment of the present application; and

FIG. 7 is a schematic block diagram of a system for integrated payment according to an embodiment of the present application.

### DETAILED DESCRIPTION

In the description, the present application will be described more fully with reference to the accompanying drawings, in which illustrative embodiments of the application are shown. This present application may, however, be embodied in many different forms and should not be construed as limited to the embodiments set forth herein. The embodiments are presented so that this disclosure will be thorough and complete, and will fully convey the protection scope of the present application to those skilled in the art.

The words “including” and “includes”, and the like, do not exclude the presence of elements or steps other than those directly and explicitly listed in any claim or the specification. Terms such as “first” and “second” do not indicate an order of elements in terms of time, space, size, etc. but rather are used to distinguish between elements.

The present application is described below with reference to flowchart illustrations, block diagrams, and/or flowcharts of methods and systems according to embodiments of the present application. It will be understood that each block of the flowchart illustrations and/or block diagrams, and combinations of the flowchart illustrations and/or block diagrams, can be implemented by computer program instructions. These computer program instructions may be provided to processors of a general purpose computer, a special purpose computer, or other programmable data processing devices to produce a machine, such that the instructions, which are executed by the processor of the computer or other programmable data processing devices, create means for implementing the functions/acts specified in the flowcharts and/or blocks and/or one or more flowchart blocks.

These computer program instructions may be loaded onto a computer or other programmable data processors to cause a series of operational steps to be performed on the computer or other programmable processors to produce a computer implemented process such that the instructions which are executed on the computer or other programmable data processors provide steps for implementing the functions or acts specified in the flowcharts and/or one or more blocks in the block diagrams. It should also be noted that in some alternative implementations, the functions/acts illustrated in the blocks may occur out of the order illustrated in the flowcharts. For example, two blocks shown in succession may in fact be executed substantially concurrently or the blocks may sometimes be executed in the reverse order, depending upon the functionality/acts involved.

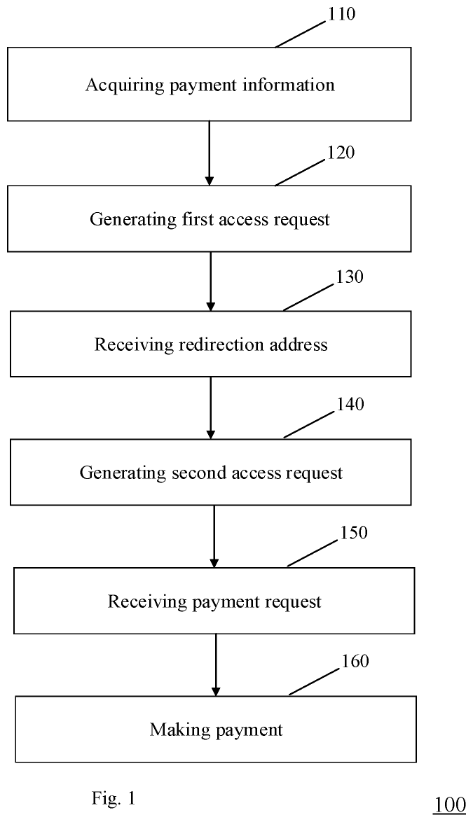

Referring to FIG. 1, FIG. 1 illustrates a schematic flowchart of a method for integrated payment 100 used at a user terminal in accordance with an embodiment of the present application.

First, in step 110, a user, typically referring to a consumer using a mobile device for consumer payment, acquires payment information associated with his order. The payment information may include a number of the order, a number of a user terminal and a number of a merchant terminal associated with the order, transaction amount information regarding the transaction order, and the like. In general, the acquiring payment information may be realized by scanning a two-dimensional code using a user terminal (hereinafter referred to as a user terminal) utilizing a third-party application (such as Wechat and Alipay), and may also be realized by a technology such as voiceprint recognition. Hereinafter, the payment manner of two-dimensional code scanning may be described as an example for the illustration of the present application. The two-dimensional code includes, but is not limited to, QR (Quick Response) Code, Code 49, Code 16K, Code One, etc. In this disclosure, the third party application refers to software that, in addition to the merchant and the user, plays a role in the transaction to facilitate the transaction process between the merchant and the user, which may be installed on both the merchant terminal and the user terminal, and may be designed differently for the merchant terminal and/or the user terminal.

In an embodiment, the merchant applies for a static payment two-dimensional code from a third party application that may be used by the user, which is typically printed on paper for the user to scan using the corresponding third party application. Since such payment two-dimensional code is static and the user terminal can only obtain the classification code of the code issuer and merchant terminal information and the like by scanning the two-dimensional code, it is required for the merchant or the user, when the payment is being made, to respectively input information associated with the transaction order through the third party application on the merchant terminal (hereinafter referred to as the merchant terminal) or the user terminal. The most commonly inputted information includes a payment amount, a payment account (that is, an acquirer as described below), and the like.

In another embodiment, for receiving the payment, the merchant applies for a dynamic payment two-dimensional code from the third party application that may be used by the user, which is typically presented to the user via an electronic screen. Since such two-dimensional code is generated based on transaction-related information inputted when the merchant applies for the two-dimensional code from the third-party application, when a user scans the two-dimensional code for payment, information such as a payment amount can be directly obtained and confirmed, without manual input by the user.

With continued reference to FIG. 1, after the user scans the two-dimensional code using the third-party application and acquires the payment information, the user terminal generates (step 120) a first access request to a system on the basis of the payment information. The first access request may include user terminal information such as user mechanism parameters and a domain name. For example, in case of a Wechat client, the user mechanism parameter value is “MicroMessenger”. A classification code of the issuer of the two-dimensional code (that is, a code issuer classification code) and an acquirer (that is, a source of the account by which a user chooses to make payment) identification (ID) may be included in the domain name for subsequently generating redirection address information.

Next, the user terminal receives (step 130) the system-generated redirection address information and then generates (step 140) a second access request to the acquirer on the basis of the redirection address information. The second access request may be an access request to the acquirer, or may be other type of access request that can cause the acquirer to generate an order and transmit a payment request to the user. In addition to indicating the determined access address (the address for accessing the acquirer), the redirection address information further includes order information corresponding to the transaction order. The order information at least includes an order number and/or one or more pieces of information of order details, and may be included in a certain URL. Subsequently, the order may be processed based on information according to the order number or the order details (for example, transaction amount, transaction object, transaction time, transaction manner, and the like). The redirection address information may further include other transaction related information as appropriate. Thus, the user terminal may access the acquirer on the basis of the redirection address information, and the user can learn and further confirm the transaction amount and the payee name of the transaction order. For example, the user terminal may access an H5 (HTML5) collection page of the acquirer. Alternatively, the redirection address information may include an acquirer ID.

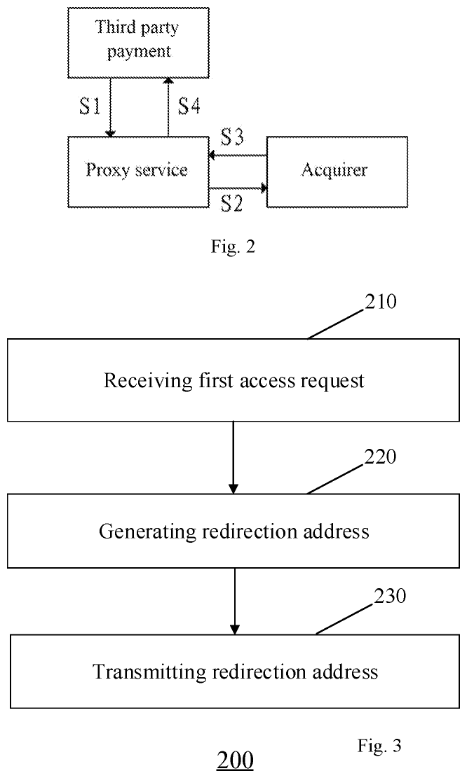

In an embodiment, the redirection of the address is performed by a proxy service. As shown in FIG. 2, an address redirection request is transmitted (S1) to the proxy service by the third party application (on a user terminal or a merchant terminal), and then the request is processed by the proxy service. Specifically, the generation of redirection address information is performed at the proxy service, and then the redirection address information is transmitted (S2) to an acquirer. The acquirer transmits (S3), for example, an H5 collection page to the proxy service, and finally the proxy service transmits (S4) the page to the third party application for subsequent payment steps.

Finally, the user terminal performs (step 160) a corresponding payment operation on the basis of the received payment request (step 150). In the payment process, for security, the payment is generally accomplished by invoking a secure payment control. With the secure payment control, when the user inputs password data, such as a password, a fingerprint, a voice print, a facial image and a dynamic image during the payment operation, the secure payment control encrypts and protects the user's account and the password data, so that the security of the user's account and the password are ensured.

Reference is now made to FIG. 3, which is a schematic flowchart of a method for integrated payment performed at a system terminal according to an embodiment of the present application.

In step 210, the system terminal receives a first access request corresponding to the payment information from the user terminal. Subsequently, based on the received first access request, the system terminal proceeds to step 220 of generating the redirection address information.

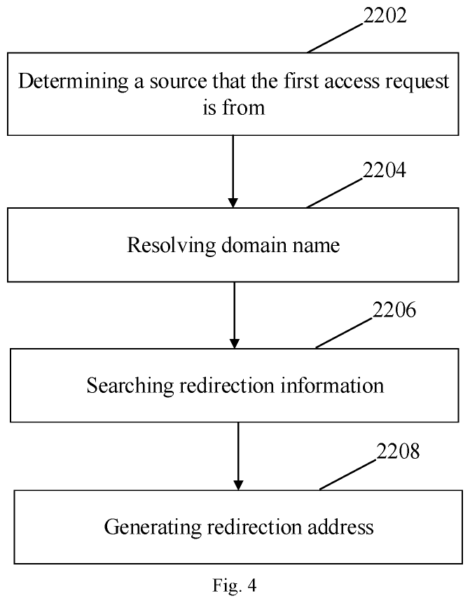

In step 220, as shown in FIG. 4, the system first performs the operations of determining (step 2202) the source of access and resolving (step 2204) the domain name. For example, in step 2202, the system terminal determines that the third-party application is Wechat on the basis of the user terminal information (for example, the user mechanism parameter value “MicroMessenger”) included in the first access request. The first access request further includes merchant terminal information, a code issuer classification code, and an acquirer ID.

Additionally, by way of example only, the domain name to which the first access request corresponds may be, for example, “https://qr.95516.com/00010000/0293819283719182”, where 0001000 represents the code issuer classification code and 0293819283719182 represents the acquirer ID. Then in the process of resolving (step 2204) the domain name, the system terminal performs the determination on the basis of the acquirer ID and the code issuer classification code. In an embodiment, if the code issuer classification code is 0001000 or 00010002, it is indicated that the two-dimensional code is a system issued code. Otherwise, the two-dimensional code is an acquirer issued code. That is, here, the code issuer classification code is used to classify the sources of the two-dimensional codes, and the code issuer classification code may be classified as the system issued code and the acquirer issued code. In the case where the two-dimensional code is the system issued code, the code issuer classification code is further used for classifying the contact between the system terminal and the merchant terminal, where 00010000 represents an indirect contact between the system terminal and the merchant terminal, and 00010002 represents a direct contact between the system terminal and the merchant terminal. The indirect contact means that the system terminal and the merchant terminal are in contact via an acquirer.

The system terminal then obtains (step 2206) information for generating the redirection address information (for example, a jump target), which is part of the redirection address information, on the basis of the merchant terminal information (for example, the merchant number) and the acquirer ID by a Look-up Table method. Specifically, the system terminal search the acquirer ID table for the acquirer and confirm the acquirer. Additionally, the system terminal further search acquirer code table for the acquirer code corresponding to the acquirer. In addition, the system terminal determines whether the merchant terminal and the third party application are in a direct contact or an indirect contact on the basis of service configuration parameters of the merchant terminal network access application. An example table of acquirer IDs, acquires codes and code issuer classification codes is shown as Table 1.

TABLE 1
Table of Acquirer IDs, Acquirer codes
and Code issuer classification codes

| | | | Code issuer |
|---|---|---|---|
| | | Acquirer | classification |
| Acquirer | Acquirer ID | code | code |
| Industrial and | 0293819283719182 | 01020000 | 00010000 |
| Commercial Bank | | | |
| Construction Bank | 0293819283719193 | 01030000 | 00010002 |
| Agricultural bank | 0293819283719104 | 01040000 | 01040000 |

The corresponding jump target may be identified in the jump target table based on the acquirer ID “0293819283719182” (or the corresponding acquirer code identified based on the acquirer ID “01020000”) and the merchant terminal information (for example, a merchant number). In other embodiments, the acquirer ID may be combined with the acquirer code to generate a combined value, thereby reducing the number of the steps for identifying the acquirer code on the basis of the acquirer ID and further saving signaling overhead. The jump target table may be stored at the system terminal or at the acquirer. An example jump target table is shown as Table 2 below.

TABLE 2
Jump Target Table

| Acquirer code | Merchant number | Jump target |
|---|---|---|
| 01020000 | 310000123456701 | https://qr.shmetro.com/pay |
| 01040000 | 310000223456702 | https://qr.abcChina.com/pay |
| 01020000 | * | https://qr.icbc.com/pay |

Referring to Table 2, in an embodiment, when the acquirer code is required, and the merchant number corresponding to the acquirer code “01020000” is “310000123456701”, which represents Shanghai Subway, then the jump target is “https://qr.shmetro.com/pay”. If the merchant number is uncertain, then the merchant number is represented as “*”, and the corresponding jump target is determined on the basis of this item.

Referring back to Table 1, in an embodiment, if the code issuer classification code is not 0001000 or 00010002, then the code issuer classification code is the acquirer code, and the merchant number and the jump target can be directly identified according to the jump target table.

After the jump target is obtained, the system performs step 2208 to generate redirection address information on the basis of the identified jump target and the order information corresponding to the transaction order.

In an embodiment, the redirection address information is in a form of “A+‘?’+B”, where A is the jump target obtained as described above, and B is payment information data. For example, when the acquirer code is “01020000”, the merchant number is “310000123456701”, the order number is “012056”, and the transaction amount information is “1000”, the jump target A is “https://qr.shmetro.com/pay” and the payment information data B is “order=012056&amount=1000”, which includes the order number (order=012056) and the transaction amount information (amount=1000). The redirection address information thus obtained is “https://qr.shmetro.com/pay?order=012056&amount=1000”.

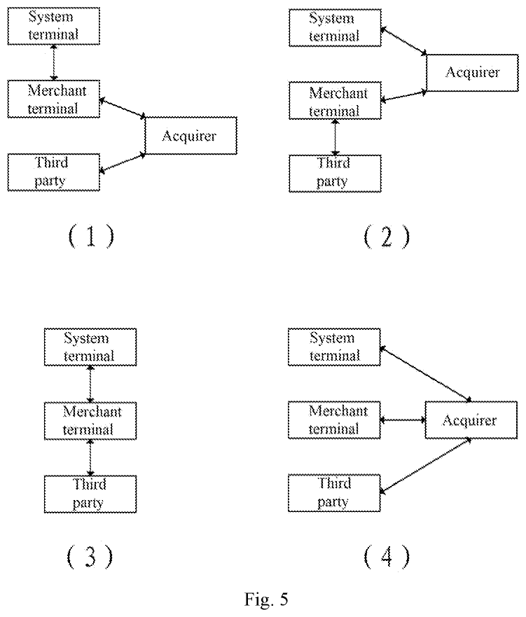

Next, the system performs step 230 to feed the generated redirection address information back to the third party application. In an embodiment, as shown in case (1) of FIG. 5, when the system terminal is in direct contact with the merchant terminal and the merchant terminal is in indirect contact with the third party application (hereinafter referred to as a third party), the system terminal transmits the redirection address information directly to the acquirer, and the acquirer directly performs processing on the basis of the order information in the redirection address information, for example, converting the order information in the redirection address information into a data form suitable for the third party. The acquirer then transmits a payment request (which includes the order information) to the third party. As such, since the redirection address information already contains the order information associated with the transaction order, the process of the system terminal first transmitting the redirection address information to the acquirer, the acquirer transmitting the address to the merchant terminal, and the merchant terminal providing payment information, such as the order information, to the acquirer is omitted, and part of the signaling overhead between the multiple parties is saved.

In another embodiment, as shown in case (2) of FIG. 5, when the system terminal is in an indirect contact with the merchant terminal and the merchant terminal is in a direct contact with the third party, the system terminal transmits the redirection address information directly to the merchant terminal (determined by the merchant number). The merchant terminal then performs processing on the basis of the order information in the redirection address information. Subsequently, the merchant terminal transmits a payment request to the third party. As such, the process of the system terminal first transmitting the redirection address information to the acquirer, the acquirer processing the order information on the basis of the received redirection address information and then transmitting the order information to the merchant terminal is omitted, and part of the signaling overhead between the multiple parties is saved.

In yet another embodiment, as shown in case (3) in FIG. 5, when the system terminal is in direct contact with the merchant terminal and the merchant terminal is in direct contact with the third party, the system terminal transmits the redirection address information to the merchant and the merchant feeds the acquirer redirection address information back to a non-system terminal system APP.

In yet another embodiment, as shown in case (4) in FIG. 5, when the system terminal is in an indirect contact with the merchant terminal and the merchant terminal is in an indirect contact with a third party, the system terminal transmits the redirection address information to the acquirer and the acquirer feeds the redirection address information to the acquirer back to the third party. Since the redirection address information already contains the order information of the transaction, such as the order number and one or more pieces of information in the order details, the process of the acquirer requesting the payment information from the merchant terminal after receiving the redirection address information, and transmitting the information to the third party after the merchant terminal feeding back the information, which saves part of the signaling overhead between the multiple parties.

Further, the redirection address information may be generated in the following manner. In an embodiment, the acquirer code is “01020000”, the merchant number is “*”, and the jump target is “https://qr.icbc.com/pay”. The redirection address information is in a form of “A+?+‘qrCode=’+C” or in a form of “A+‘?’+B+‘&’+‘qrCode’=+C”, where A is the obtained jump target, B is the payment information data, and C is the dynamic data containing the two-dimensional code, as described above. The dynamic data may be the payment information obtained by the third party by scanning the two-dimensional code as described above, such as a URL (https://qr.95516.com/00010000/0293819283719182), that is, https %3a%2f%2fqr.95516.com %2f%3c00010000%3e%2f%3c0293819283719182%3e, which includes the code issuer classification code and the acquirer ID. The third party application then determines the redirection address information on the basis of the dynamic data.

In an embodiment, the redirection of the address is performed by a proxy service. As shown in FIG. 2, an address redirection request is transmitted (S1) to the proxy service by the third party application (on a user terminal or a merchant terminal), and then the request is processed by the proxy service. Specifically, the generation of redirection address information is performed in the proxy service, and then the redirection address information is transmitted (S2) to an acquirer. The acquirer transmits (S3), for example, an H5 collection page to the proxy service, and finally the proxy service transmits (S4) the page to the third party application for subsequent payment steps.

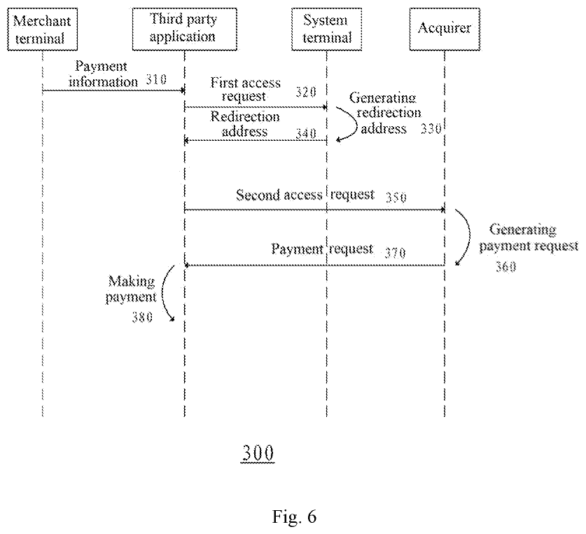

FIG. 6 is an overall timing diagram 300 of a method for integrated payment according to an embodiment of the application. To make the present application be readily understood, a method for integrated payment according to an embodiment of the present application will now be described in its entirety with reference to FIG. 6. First, in step 310, payment information is acquired by a third party application (for example, a two-dimensional code provided by a merchant terminal). Then, in step 320, a corresponding first access request to a system terminal is generated based on the payment information. In step 330, redirection address information is generated by the system terminal in response to the first access request. In step 340, the redirection address information is transmitted by the system terminal to the third party application. Then, in step 350, a corresponding second access request to the acquirer is generated by the third party application on the basis of the received redirection address information. In step 360, a payment request is generated by the acquirer in response to the second access request. In step 370, the payment request is transmitted by the acquired to the third party application. Finally, in step 380, a payment operation is performed by the third party application perform (e.g. via a secure payment control).

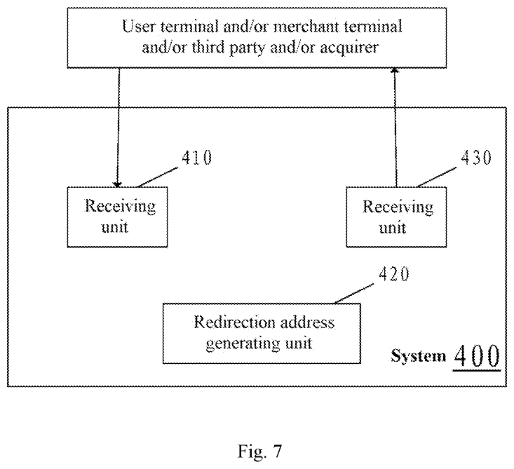

FIG. 7 is a schematic block diagram of a system 400 for integrated payment according to an embodiment of the present application. As shown in FIG. 7, the system 400 includes a receiving unit 410, a redirection address information generating unit 420, and a transmitting unit 430. The system 400 communicates directly or indirectly with a user terminal, a merchant terminal or an acquirer through a receiving unit 410 and a transmitting unit 430. Although the receiving unit 410 and the transmitting unit 430 are shown as separated in FIG. 7, it can be understood that, the functions of these two units may be performed by one unit (for example, a transceiver unit) or may be incorporated into other units in the system. In an embodiment, the receiving unit 410 is configured to receive a first access request corresponding to the payment information from the user terminal.

Subsequently, the redirection address information generating unit 420 generates redirection address information on the basis of the received first access request. The redirection address information generating unit 420 may further include a request source determining unit 4202, a domain name resolving unit 4204, a redirection information determining unit 4206, and a redirection address information generating unit 4208 (not shown in FIG. 7). The request source determining unit 4202 is configured to determine the source of the access request to the system, that is, the type of third party application that initiates the access to the system. In an embodiment, the request source determining unit 4202 may determine that the third-party application is Wechat on the basis of the user terminal information included in the first access request, for example, the user mechanism parameter value “MicroMessenger”. The first access request further includes merchant terminal information, a code issuer classification code, and an acquirer ID.

The domain name resolving unit 4204 is configured to resolve the domain name corresponding to the first access request to acquire payment information therein. By way of example only, the domain name to which the first access request corresponds may be, for example, “https://qr.95516.com/00010000/0293819283719182”, where 0001000 represents the code issuer classification code and 0293819283719182 represents the acquirer ID. The domain name resolving unit 4204 determines the identity of the acquirer on the basis of the acquirer ID. The domain name resolving unit 4204 may perform the determination based on the acquirer ID and the code issuer classification code. In an embodiment, if the issuer classification code is 0001000 or 00010002, the domain name resolving unit 4204 determines that the two-dimensional code is a system-issued code, and otherwise the domain name resolving unit 4204 determines that the two-dimensional code is an acquirer-issued code. That is, here, the code issuer classification code is used to classify the sources of the two-dimensional codes, and the code issuer classification code may be classified as the system issued code and the acquirer issued code. In the case where the two-dimensional code is the system issued code, the code issuer classification code is further used for classifying the contact between the system terminal and the merchant terminal, where 00010000 represents an indirect contact between the system terminal and the merchant terminal, and 00010002 represents a direct contact between the system terminal and the merchant terminal. The indirect contact means that the system terminal and the merchant terminal are connected via an acquirer.

The redirection information determining unit 4206 may then obtain (step 2206) information for generating the redirection address information (for example, a jump target), which is part of the redirection address information, on the basis of the merchant terminal information (for example, the merchant number) and the acquirer ID by a Look-up Table method. Specifically, the redirection information determining unit 4206 may search the acquirer ID table for the acquirer and confirm the acquirer. Additionally, redirection information determining unit 4206 may further search acquirer code table for the acquirer code corresponding to the acquirer. In addition, the redirection information determining unit 4206 may determine whether the merchant terminal and the third party application are in a direct contact or an indirect contact on the basis of service configuration parameters of the merchant terminal network access application. An example table of acquirer IDs, acquire codes and code issuer classification codes is shown as Table 1.

The corresponding jump target may be identified by the redirection information determining unit 4206 in the jump target table based on the acquirer ID “0293819283719182” (or the corresponding acquirer code identified based on the acquirer ID “01020000”) and the merchant terminal information (for example, the merchant number). In other embodiments, the acquirer ID may be combined with the acquirer code to generate a combined value, thereby reducing the number of the steps of finding the acquirer code on the basis of the acquirer ID and further saving signaling overhead. The jump target table may be stored at the system terminal or at the acquirer. An example jump target table is shown as Table 2 below.

Referring to Table 2, in an embodiment, when the acquirer code is required, and the merchant number corresponding to the acquirer code “01020000” is “310000123456701”, which represents Shanghai Subway, then the jump target is “https://qr.shmetro.com/pay”. If the merchant number is uncertain, then the merchant number is represented as “*”, and the corresponding jump target is determined on the basis of this item.

Referring back to Table 1, in an embodiment, if the code issuer classification code is not 0001000 or 00010002, then the code issuer classification code is the acquirer code, and the merchant number and the jump target can be directly identified according to the jump target table.

After the jump target is obtained, the redirection address information generating unit 4208 may be configured to generate redirection address information on the basis of the identified jump target and the order information corresponding to the transaction order. The redirection address information generating unit 4208 may further be configured to encapsulate the order information corresponding to the transaction order into the redirection address information.

In an embodiment, the redirection address information is in a form of “A+‘?’+B”, where A is the jump target obtained as described above, and B is the payment information data. For example, when the acquirer code is “01020000”, the merchant number is “310000123456701”, the order number is “012056”, and the transaction amount information is “1000”, the jump target A is “https://qr.shmetro.com/pay”, the payment information data B is “order=012056&amount=1000”, which includes the order number (order=012056) and the transaction amount information (amount=1000). The redirection address information thus obtained is “https://qr.shmetro.com/pay?order=012056&amount=1000”.

The transmitting unit 430 is configured to feed the generated redirection address information back to the third party application. In an embodiment, as shown in case (1) of FIG. 5, when the system terminal is in direct contact with the merchant terminal and the merchant terminal is in indirect contact with the third party application (hereinafter referred to as a third party), the transmitting unit 430 may transmit the redirection address information directly to the acquirer, and the acquirer directly performs processing according to the order information in the redirection address information, for example, converting the order information in the redirection address information into a data form suitable for the third party. The acquirer then transmits a payment request (which includes the order information) to the third party. As such, since the redirection address information already contains the order information associated with the transaction order, the process of the transmitting unit 430 of the system first transmitting the redirection address information to the acquirer, the acquirer transmitting the address to the merchant terminal, and the merchant terminal providing payment information, such as the order information, to the acquirer is omitted, and part of the signaling overhead between the multiple parties is saved.

In another embodiment, as shown in case (2) of FIG. 5, when the system terminal is in an indirect contact with the merchant terminal and the merchant terminal is in a direct contact with the third party, the transmitting unit 430 transmits the redirection address information directly to the merchant terminal (determined by the merchant number). The merchant terminal then performs processing on the basis of the order information in the redirection address information. Subsequently, the merchant terminal transmits a payment request to the third party. As such, the process of the transmitting unit 430 first transmitting the redirection address information to the acquirer, the acquirer processing the order information on the basis of the received redirection address information and then transmitting the order information to the merchant terminal is omitted, and part of the signaling overhead between the multiple parties is saved.

In yet another embodiment, as shown in case (3) in FIG. 5, when the system terminal is in direct contact with the merchant terminal and the merchant terminal is in direct contact with the third party, the transmitting unit 430 transmits the redirection address information to the merchant and the merchant feeds the acquirer redirection address information back to a non-system terminal system APP.

In yet another embodiment, as shown in case (4) in FIG. 5, when the system terminal is in an indirect contact with the merchant terminal and the merchant terminal is in an indirect contact with a third party, the transmitting unit 430 may transmit the redirection address information to the acquirer and the acquirer feeds the redirection address information to the acquirer back to the third party. Since the redirection address information already contains the order information of the transaction, such as the order number and one or more pieces of information in the order details, the process of the acquirer requesting the payment information from the merchant terminal after receiving the redirection address information, and transmitting the information to the third party after the merchant terminal feeding back the information, which saves part of the signaling overhead between the multiple parties.

Further, redirection address information generating unit 4208 may be configured to generate the redirection address information in the following manner. In an embodiment, the acquirer code is “01020000”, the merchant number is “*”, and the jump target is “https://qr.icbc.com/pay”. The redirection address information is in a form of “A+?+′qrCode=′+C” or in a form of “A+‘?’+B+‘&’+‘qrCode’=+C”, where A is the obtained jump target, B is the payment information data, and C is the dynamic data containing the two-dimensional code, as described above. The dynamic data may be the payment information obtained by the third party by scanning the two-dimensional code as described above, such as a URL (https://qr.95516.com/00010000/0293819283719182), that is, https%3a%2f%2fqr.95516.com %2f%3c00010000%3e%2f%3c0293819283719182%3e, which includes the code issuer classification code and the acquirer ID. The third party application then determines the redirection address information on the basis of the dynamic data.

In an embodiment, the redirection of the address is performed by a proxy service. As shown in FIG. 2, an address redirection request is transmitted (S1) to the proxy service by the third party application (on a user terminal or a merchant terminal), and then the request is processed by the proxy service. Specifically, the generation of redirection address information is performed in the proxy service, and then the redirection address information is transmitted (S2) to an acquirer. The acquirer transmits (S3), for example, an H5 collection page to the proxy service, and finally the proxy service transmits (S4) the page to the third party application for subsequent payment steps.

The embodiments and examples set forth herein are presented to best explain the embodiments in accordance with the present technologies and their particular applications and to thereby enable those skilled in the art to implement and use the application. However, those skilled in the art will appreciate that the foregoing description and examples have been presented for the purpose of illustration and example only. The description as set forth is not intended to cover any aspects of the present application or to limit the present application to the precise form disclosed.

1. A method for integrated payment, comprising:
receiving, from a user terminal, a first access request corresponding to payment information;
generating redirection address information on the basis of the first access request; and
transmitting the redirection address information to the user terminal;
wherein the redirection address information comprises jump target information and order information corresponding to a transaction order to be paid.

2. The method for integrated payment according to claim 1, wherein the order information comprises an order number and/or one or more pieces of information of order details.

3. The method for integrated payment according to claim 1, wherein the generating redirection address information is performed by a proxy service.

4. The method for integrated payment according to claim 1, wherein the first access request comprises user terminal information, merchant terminal information, a code issuer classification code, and an acquirer identification (ID).

5. The method for integrated payment according to claim 1, wherein the redirection address information further comprises acquirer information.

6. The method for integrated payment according to claim 4, wherein the generating the redirection address information comprises:
obtaining, by a Look-up Table method, information for generating the redirection address information on the basis of the merchant terminal information and the acquirer ID.

7. The method for integrated payment according to claim 1, wherein the transmitting the redirection address information to the user terminal comprises:
transmitting the redirection address information to the user terminal via a merchant terminal; or
transmitting the redirection address information to the user terminal via an acquirer.

8. A method for integrated payment, comprising:
acquiring, from a merchant terminal, payment information of an order;
generating a first access request on the basis of the payment information;
receiving redirection address information generated on the basis of the first access request;
generating a second access request on the basis of the redirection address information;
receiving a payment request based on the second access request; and
making payment on the basis of the payment request;
wherein the redirection address information comprises jump target information and order information corresponding to a transaction order to be paid.

9. The method for integrated payment according to claim 8, wherein the order information comprises an order number and/or one or more pieces of information of order details.

10. The method for integrated payment according to claim 8, wherein the generating redirection address information is performed by a proxy service.

11. The method for integrated payment according to claim 8, wherein the first access request comprises user terminal information, merchant terminal information, a code issuer classification code, and an acquirer ID.

12. The method for integrated payment according to claim 8, wherein the redirection address information further comprises acquirer information.

13. The method for integrated payment according to claim 11, wherein the acquiring, from a merchant terminal, payment information of an order comprises:
acquiring the order information by acquiring two-dimensional code information.

14. The method for integrated payment according to claim 8, wherein the making payment on the basis of the payment request comprises:
making payment by invoking a payment control.

15. A system for integrated payment, comprising a processor and a memory having a computer program instruction stored thereon, wherein the processor is configured to execute the computer program instruction to:
receive a first access request from a user terminal;
generate redirection address information on the basis of the first access request; and
transmit the redirection address information to the user terminal;
encapsulate jump target information and order information corresponding to a transaction order to be paid into the redirection address information.

16. The system for integrated payment according to claim 15, wherein the order information comprises an order number and/or one or more pieces of information of order details.

17. The system for integrated payment according to claim 15, wherein the processor is further configured to execute the computer program instruction to to generate the redirection address information through a proxy service.

18. The system for integrated payment according to claim 15, wherein the first access request further comprises user terminal information, merchant terminal information, a code issuer classification code, and an acquirer identification (ID).

19. The system for integrated payment according to claim 15, wherein the redirection address information further comprises acquirer information.

20. The system for integrated payment according to claim 18, wherein the processor is further configured to execute the computer program instruction to obtain, by a Look-up Table method, information used for generating the redirection address information on the basis of the merchant terminal information and the acquirer ID.

21. (canceled)
